(19) United States
(12) Patent Application Publication
(10) Pub. No.: US 2011/0302490 A1
(43) Pub. Date: Dec. 8, 2011

(54) IMAGE PROCESSING APPARATUS, IMAGE FORMING SYSTEM, AND IMAGE DISPLAYING METHOD

(75) Inventor: Shoji Koarai, Osaka (JP)

(73) Assignee: Sharp Kabushiki Kaisha, Osaka (JP)

(21) Appl. No.: 13/154,649

(22) Filed: Jun. 7, 2011

(30) Foreign Application Priority Data
Jun. 7, 2010 (JP) JP2010-130313

(51) Int. Cl. G06F 17/00

(52) U.S. Cl. 715/274

(57) ABSTRACT

A preview image generating part acquires printing data and then generates a plurality of preview images. A display control part stacks the plurality of generated preview images in the page order and displays two adjacent preview images in the front row. A reverse display control part page-feeds one preview image in the front row sequentially and gradually and reverses the front face to the back face, and then adopts it as the other-side preview image in the front row.

### CROSS-REFERENCE TO RELATED APPLICATIONS

This Nonprovisional application claims priority under 35 U.S.C. §119(a) on Patent Application No. 2010-130313 filed in Japan on Jun. 7, 2010, the entire contents of which are hereby incorporated by reference.

### BACKGROUND

1. Technical Field

The present invention relates to: an image processing apparatus performing image processing of displaying, onto a display screen, document images before printing; an image forming system employing this image processing apparatus; and a computer program and an image displaying method implementing this image processing apparatus.

2. Description of Related Art

Image processing apparatuses or image forming apparatuses are commercially available that are provided with a preview function of, before a document prepared by a document preparation application operating on an image processing apparatus such as a personal computer is actually printed through an image forming apparatus such as a printer, displaying preview images for the purpose of checking the finished state of the document expected to be obtained after the printing.

For example, an image forming apparatus is disclosed (see Japanese Patent Application Laid-Open No. 2006-3568) in which before the operator executes the printing, the expected finished state of the document is displayed in stereography in a display part, and then when the operator requests the subsequent pages, the pages of the document are displayed sequentially in stereographic animation.

Further, an image forming apparatus is disclosed (see Japanese Patent Application Laid-Open No. 2009-253777) in which an animation of transition process from the preview image presently displayed in a preview region into the foregoing page or the subsequent page is generated so that visibility is improved in the relation between the pages of the document under the image formation.

Further, as a general technique of converting a temporary file into a stereographic image, for example, a technique of projective transformation of a plane figure is known (see Japanese Patent Application Laid-Open No. 11-312238).

### SUMMARY OF THE INVENTION

In the apparatuses disclosed in Japanese Patent Application Laid-Open No. 2006-3568 and Japanese Patent Application Laid-Open No. 2009-253777, the expected finished state of the document before printing execution is displayed in preview so that check is allowed by an animation or the like. Thus, an effect of avoiding erroneous printing not desired by the operator is obtained to an extent. Nevertheless, situations of printing a document consisting of a large number of document images are increasing in recent years. This causes an increase in the work load in checking the expected finished state obtained by the printing, by means of preview display of the document images consisting of a large number of pages. Thus, a desire has been present that in a case that document images before printing are to be displayed in preview, visibility to the operator is improved further so that erroneous printing is avoided.

The present invention has been devised in view of such a situation. Its object is to provide: an image processing apparatus capable of improving the visibility in a case that document images before printing are to be displayed in preview; and an image forming system and an image displaying method that employ this image processing apparatus.

An image processing apparatus according to the present invention is an image processing apparatus that includes an image generating part generating a plurality of document images on the basis of printing data of a document to be printed and that performs processing of displaying the generated document images onto a display screen, comprising: a display control part performing control such as to stack the plurality of document images generated by the image generating part and display two adjacent document images into the front row in an aligned manner with each other; and a reverse display control part moving gradually and sequentially one document image in the front row displayed by the display control part and reversing the front face to the back face, and then adopting it as the other-side preview image in the front row.

An image processing apparatus according to the present invention has a configuration that the display control part performs displaying such that the document images in the front row cover a part of a document image in the back row among the stacked document images.

An image processing apparatus according to the present invention comprises a movement speed control part controlling a speed of document image movement performed by the reverse display control part.

An image processing apparatus according to the present invention has a configuration that the display control part displays the document images in such a manner that the plurality of document images are stood vertically on a reference surface in the display screen, in at least one of a first display mode that two document images in the front row face with each other at a given angle and a second display mode that the two document images in the front row is placed on a placement surface in the display screen, and in accordance with the first display mode or the second display mode, the movement speed control part controls the speed of document image movement performed by the reverse display control part.

An image processing apparatus according to the present invention has a configuration that the reverse display control part moves the document images gradually on the reference surface.

An image processing apparatus according to the present invention comprises: an editing condition judging part judging an editing condition for the document; and a movement speed control part controlling the speed of document image movement performed by the reverse display control part, in accordance with the editing condition judged by the editing condition judging part.

An image processing apparatus according to the present invention has a configuration that the editing condition judging part judges the presence or absence of a chapter change in the document, and in case of the presence of a chapter change in the document, the movement speed control part reduces the speed of the movement of the document images of the document or alternatively stops temporarily the movement.

An image processing apparatus according to the present invention has a configuration that the editing condition judging part judges the presence or absence of a size change in the document, and in case of the presence of a size change in the document, the movement speed control part reduces the speed of the movement of the document images of the document or alternatively stops temporarily the movement.

An image processing apparatus according to the present invention has a configuration that the editing condition judging part judges the size of the document, and in accordance with the size of the document, the movement speed control part controls the speed of movement of the document images of the document.

An image processing apparatus according to the present invention comprises: a reception part receiving a print condition; and a movement speed control part controlling the speed of document image movement performed by the reverse display control part, in accordance with the print condition received by the reception part.

An image processing apparatus according to the present invention has a configuration that the reception part receives a print color specification or alternatively the number of document pages to be assigned to one page.

An image processing apparatus according to the present invention comprises: a position setting part setting the depth position of the document images in the front row displayed by the display control part, on a reference surface in the display screen; and a movement speed control part, in accordance with the position set up by the position setting part, controlling the speed of document image movement performed by the reverse display control part.

An image processing apparatus according to the present invention comprises: a position setting part setting a binding position of sheets; and a movement speed control part performing control such that the speed of document image movement performed by the reverse display control part should be identical for both cases of top binding and of left or right binding of the sheets set up by the position setting part.

An image processing apparatus according to the present invention comprises: a position setting part setting a binding position of sheets; and a switching part switching a direction of the document image movement performed by the reverse display control part, in accordance with the binding position set up by the position setting part.

An image processing apparatus according to the present invention comprises a determination part determining whether the operation that one document image in the front row is reversed and then adopted as the other-side document image in the front row and that is performed through the reverse display control part is to be performed manually or automatically.

An image processing system according to the present invention comprises: the image processing apparatus according to the above-mentioned invention; and an image forming apparatus forming images by using print data corresponding to the document images displayed by the image processing apparatus.

An image processing method according to the present invention is an image displaying method employing an image processing apparatus that generates a plurality of document images on the basis of printing data of a document to be printed and that performs processing of displaying the generated document images onto a display screen, comprising: a step of stacking and displaying the plurality of generated document images; a step of moving document images in the front row gradually and sequentially and reversing the front face to the back face; and a step of adopting sequentially the reversed document images as document images in the front row and displaying two adjacent document images into the front row in an aligned manner with each other.

In the present invention, the printing data of a document to be printed is data to be outputted to the image generating part when operation of printing execution is performed in a document preparation application. Further, the printing data includes, for example, print data itself and metadata associated with the printing. The document images are preview images to be displayed in preview on the display screen before the printing through the printer or the like. The display control part performs control such as to stack the plurality of generated document images and display two adjacent document images into the front row in an aligned manner with each other. Here, at the time of display in an aligned manner, the two document images may be apart from each other or alternatively may be in contact to each other (may overlap with each other). This allows two successive pages of document images to be displayed simultaneously on the display screen. The reverse display control part moves (page-feeds) one document image in the front row sequentially and gradually and reverses the front face to the back face, and then adopts it as the other-side document image in the front row. For example, when one document image in the front row is recognized as a front face, the document image is gradually reversed from the front face to the back face. Thus, the operator is allowed to see a situation that the document images gradually changes from the front page to the back page. Thus, visibility of document images is improved further. Further, even in a case that a document consisting of a large number of document images are to be printed, the presence or absence of a printing error is checked reliably.

In the present invention, the display control part performs display such that the document images in the front row among the stacked document images cover a part of the document image in the back row. Thus, when the document images are displayed in a stacked manner, document images in the front row cover merely a part of the document image in the back row. This allows the document image in the back row to be seen simultaneously to the document images in the front row. That is, the situation of the overall document is seen together with the document images in the front row. Thus, visibility is improved further.

In the present invention, the movement speed control part controls the speed of movement (page feed) of document images. For example, in an exemplary case that a user checks document images, the user checks the document images in a page-feed manner. This is so-called “skimming (skim reading)”. When skim reading is to be performed, the speed of page feed may be relatively high. This saves time. Nevertheless, a possibility arises that pages requiring care are skipped among the document images so that printing mistakes are caused. In the configuration that the speed of movement (page feed) of the document images is controlled such that, for example, page feed is stopped temporarily or alternatively the speed of page feed is set reduced so that the user's attention is attracted, printing mistakes are reduced.

In the present invention, the display control part stands vertically a plurality of document images onto the reference surface in the display screen and then displays the document images in the first display mode that two document images in the front row oppose to each other at a given angle. Display of the reference surface may be, for example, in a manner that the reference surface is viewed from oblique above. Alternatively, the display control part displays the document images in the second display mode that two document images in the front row are placed on the placement surface in the display screen. The movement speed control part controls the speed of movement (page feed) of document images in accordance with the first display mode or second display mode. For example, the first display mode is a mode that document images before printing are displayed in stereography, and is an aspect that two pages of the document are displayed in stereography as if a two-page spread is stood vertically on a desk. For example, the second display mode is a mode that document images before printing are displayed in the form of a plane figure, and is an aspect that two pages of the document are displayed as if a two-page spread is placed on a desk. In the second display mode, two pages of the document are displayed as if a two-page spread is placed on a desk. Further, display is such that page feed is performed page by page. Thus, visibility is improved further. For example, in the first display mode (stereographic display), the movement speed control part assumes that the relation of the front face and the back face of a document sheet is to be checked rapidly, and hence sets the speed of page feed to be relatively high. In the second display mode (plane-figure display), the movement speed control part assumes that the contents of each page of the document is to be checked carefully, and hence sets the speed of page feed is set relatively low. Thus, the speed of movement (page feed) of the document images is allowed to be changed in accordance with the display mode for the document images. This improves visibility and convenience to the operator.

In the present invention, the reverse display control part moves the document images gradually on the reference surface, and reverses the front face to the back face. By virtue of this, two pages of the document are displayed in a stereographic manner as if a two-page spread is stood vertically on a desk. Further, display is such that page feed is performed page by page. Thus, visibility is improved further.

In the present invention, an editing condition for a document is judged. Then, in accordance with the judged editing condition, the speed of document image movement (page feed) performed by the reverse display control part is controlled. For example, when a given editing condition is set up, for the purpose of checking whether the editing condition is reflected correctly, such control is allowed that the speed of movement (page feed) of the document images is set to be relatively low or alternatively stopped temporarily. Thus, careful and with-sufficient-time checking is allowed to be performed on parts easily suffering erroneous printing depending on the editing condition. This avoids erroneous printing.

In the present invention, the presence or absence of a chapter change in a document is judged. Then, in case of the presence of a chapter change in the document, the speed of movement (page feed) of the document images of the document is set reduced or alternatively the movement (page feed) is stopped temporarily. This allows reliable checking of parts easily suffering erroneous printing, like a chapter change in the document.

In the present invention, the presence or absence of a size change in a document is judged. Then, in case of the presence of a size change in the document, the speed of movement (page feed) of the document images of the document is set reduced or alternatively the movement (page feed) is stopped temporarily. This allows reliable checking of parts easily suffering erroneous printing, like a size change in the document.

In the present invention, the document size is judged. Then, in accordance with the document size, the speed of movement (page feed) of the document images of the document is controlled. For example, like in the case of A2, A3, or the like, when the document size is larger than an ordinary size (e.g., A4), the area to be checked is necessarily large. Thus, the speed of page feed is set reduced. Further, like in the case of B6, A5, or the like, when the document size is smaller than the ordinary size, the area to be checked is necessarily small. Thus, the speed of page feed is set increased. By virtue of this, the speed of page feed is changed depending on the expected number of parts easily suffering erroneous printing, like the document size. This permits rapid and reliable checking.

In the present invention, in accordance with the received print condition, the speed of document image movement (page feed) performed by the reverse display control part is controlled. For example, when a given print condition is set up, for the purpose of checking whether the print condition is reflected correctly, such control is allowed that the speed of movement (page feed) of the document images is set to be relatively low or alternatively stopped temporarily. Thus, careful and with-sufficient-time checking is allowed to be performed on parts easily suffering erroneous printing depending on the print condition. This avoids erroneous printing.

In the present invention, as a print condition, a print color specification or alternatively the number of document pages to be assigned to one page is received. For example, the print color specification is distinction between color and monochrome. For example, when printing is to be performed in color, the number of to-be-checked items, like color tone, increases. Thus, the speed of page feed is set relatively low. Further, when printing is to be performed in monochrome, the number of to-be-checked items decreases in comparison with the case of color printing. Thus, the speed of page feed is set relatively high. Further, the number of document pages to be assigned to one page is expressed by the page assignment number indicating the number of document pages to be assigned to one sheet. For example, in case of a high page assignment number, the speed of page feed is set relatively high in order that page-to-page balance or the like is allowed to be checked easily. Further, in case of a low page assignment number, the speed of page feed is set relatively low in order that each page is allowed to be checked carefully. Thus, careful and with-sufficient-time checking is allowed to be performed on parts easily suffering erroneous printing depending on the print condition. This avoids erroneous printing.

In the present invention, the depth position of the document images in the front row is set up on the reference surface in the display screen. Then, in accordance with the set-up position, the speed of document image movement (page feed) performed by the reverse display control part is controlled. For example, when arrangement is such that the depth position of the document images in the front row is located on the far side, it is assumed that the relation of the front face and the back face of each document sheet is checked rapidly. Thus, the speed of page feed is set relatively high. Further, when arrangement is such that the depth position of the document images in the front row is located on the near side, it is assumed that the contents of each page of the document is to be checked carefully. Thus, the speed of page feed is set relatively low. Thus, the speed of movement (page feed) of the document images is allowed to be changed in accordance with the display mode for the document images. This improves visibility and convenience to the operator.

In the present invention, provided are: the position setting part setting up the binding position of the sheets and the movement speed control part performing control such that the speed of movement of the document images should be identical for both cases of top binding and of left or right binding. Thus, in either case of top binding or of left or right binding, page feed is performed at the same speed. Thus, the user's feeling of operation does not change regardless of the binding position of the sheets, and hence operation is achieved without uneasiness.

In the present invention, the binding position of the sheets is set up. Then, in accordance with the set-up binding position, the direction of the document image movement performed by the reverse display control part. For example, when the binding position is on the left side of the document, the direction of page feed of the document images is set to be from right to left. Further, when the binding position is on the top side of the document, the direction of page feed of the document images is set to be from bottom to top. When the binding position is on the upper left side of the document, the direction of page feed of the document images is set to be from lower right to upper left. Thus, page feed is performed in a manner that the state of binding of the document is reproduced. Accordingly, check is performed in a state that the actually expected finished state like the sequence of the pages and the top and bottom of the document is reproduced. This permits easy finding of erroneous printing.

In the present invention, the determination part is provided that determines whether the operation of reversing one document image in the front row and then adopting it as the other-side document image in the front row is to be performed y manually or automatically. By virtue of this, when the operator desires rapid check, automatic page feed is available. Further, when the operator desires to carefully check the pages one by one, manual page feed is available. This improves convenience in accordance with the operator's desire.

In the present invention, provided are: the image processing apparatus; and the image forming apparatus forming images by using print data corresponding to the document images displayed by the image processing apparatus. This allows the printing to be performed after the checking of the document images before printing.

According to the present invention, the operator is allowed to see a situation that the document images gradually changes from the front page to the back page. Thus, visibility of the document images is improved. Further, even in a case that a document consisting of a large number of document images are to be printed, the presence or absence of a printing error is checked reliably.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram illustrating an example of a configuration of an image forming system employing an image processing apparatus according to an embodiment of the present invention;

FIG. 2 is a schematic diagram illustrating an example of an entire process of preview display performed by an image processing apparatus according to an embodiment of the present invention;

FIG. 3 is an explanation diagram illustrating an example of preview display in a document display mode according to an embodiment of the present invention;

FIG. 4 is an explanation diagram illustrating an example of preview display in a stereographic display mode according to an embodiment of the present invention;

FIG. 5 is an explanation diagram illustrating an example of preview display in a plane-figure display mode according to an embodiment of the present invention;

FIG. 6 is an explanation diagram illustrating an example of transition in page feed in a stereographic display mode according to an embodiment of the present invention;

FIG. 7 is an explanation diagram illustrating an example of transition in page feed in a stereographic display mode according to an embodiment of the present invention;

FIG. 8 is an explanation diagram illustrating an example of transition in page feed in a stereographic display mode according to an embodiment of the present invention;

FIG. 9 is an explanation diagram illustrating an example of transition in page feed in a stereographic display mode according to an embodiment of the present invention;

FIG. 10 is an explanation diagram illustrating an example of preview display in a case of top binding according to an embodiment of the present invention;

FIG. 11 is an explanation diagram illustrating an example of preview display in a case of upper left binding according to an embodiment of the present invention;

FIG. 12 is a flow chart illustrating an entire processing procedure of preview display performed by an image processing apparatus according to an embodiment of the present invention;

FIG. 13 is a flow chart illustrating a processing procedure of preview display in a case that the page feed speed is set reduced according to an embodiment of the present invention;

FIG. 14 is a flow chart illustrating a processing procedure of preview display in a case that page feed is stopped temporarily according to an embodiment of the present invention;

FIG. 15 is a flow chart illustrating a processing procedure of preview display in a case that the page feed speed is changed according to an embodiment of the present invention;

FIG. 16 is a flow chart illustrating another processing procedure of preview display in a case that the page feed speed is changed according to an embodiment of the present invention; and

FIG. 17 is an explanation diagram illustrating a recording medium storing a program performing preview display processing.

### DETAILED DESCRIPTION

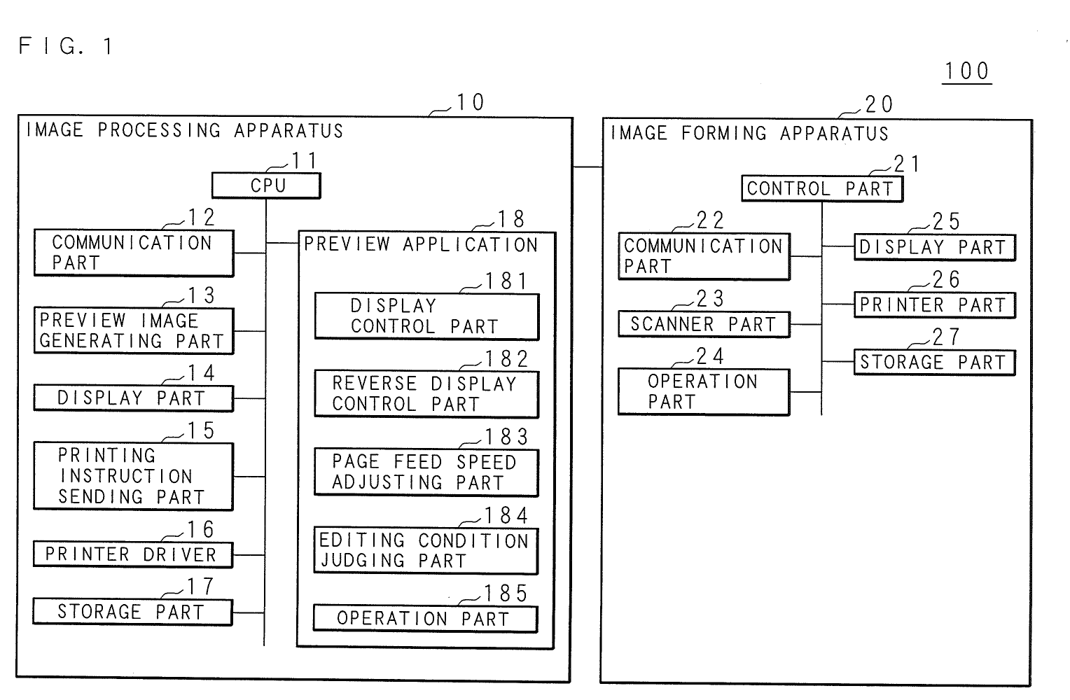

The present invention is described below with reference to the drawings illustrating embodiments. FIG. 1 is a block diagram illustrating an example of a configuration of an image forming system 100 employing an image processing apparatus 10 according to an embodiment of the present invention. The image forming system 100 includes: an image processing apparatus 10 such as a personal computer; and an image forming apparatus 20 such as a printer. The image processing apparatus 10 and the image forming apparatus 20 are allowed to exchange data with each other through a communication line or the like. Here, the image processing apparatus 10 and the image forming apparatus 20 may be integrated into a multi function peripheral provided with a copy function, a printer function, a filing function, a facsimile transmitting function, a Scan to E-mail function, and the like.

The image processing apparatus 10 includes: a CPU 11 controlling the entire apparatus; a communication part 12; a preview image generating part 13; a display part 14 such as a liquid crystal display and a liquid crystal panel; a printing instruction sending part 15; a printer driver 16; a storage part 17 such as a ROM, a RAM, a hard disk, a CD-ROM drive, and/or a DVD drive; a preview application 18. Here, in this configuration, the display part 14 is provided within the image processing apparatus 10. Instead, the display part 14 may be provided separately from the image processing apparatus 10.

The preview application 18 includes a display control part 181, a reverse display control part 182, a page feed speed adjusting part 183, an editing condition judging part 184, and an operation part 185.

The CPU 11 executes a document preparation application or the like loaded onto the RAM of the storage part 17. This allows the operator to prepare a document containing texts, diagrams, and the like.

The communication part 12 exchanges given data with the image forming apparatus 20 or other external device through a network or a communication line. For example, the communication part 12 transmits print data to the image forming apparatus 20.

The preview image generating part 13 has the function of serving as an image generating part acquiring printing data of a document to be printed and then generating a plurality of preview images (document images). The printing data is, for example, data to be outputted to the preview image generating part 13 when operation of printing execution is performed in the document preparation application, and contains print data itself and metadata associated with the printing (e.g., information concerning the sheet size, the resolution, and the sheet direction). The preview images (the document images) are, for example, in the form of a temporary file of EMF (enhanced metafile) data, and are images used for preview display performed by the display part (display screen) 14 before the printing is executed by the image forming apparatus 20 such as a printer.

The preview image generating part 13 generates the preview images (a temporary file) page by page, and then outputs the generated preview images (a temporary file) to the preview application 18.

The display control part 181 has the function of serving as a display control part performing control such that the plurality of generated preview images are stacked in the page order and then two adjacent preview images are displayed in the front row in an aligned manner. Here, at the time of display in an aligned manner, the two preview images may be apart from each other or alternatively may be in contact to each other (may overlap with each other). This allows two successive pages of the preview images to be displayed simultaneously on the display screen of the display part 14.

The reverse display control part 182 has the function of serving as a reverse display control part moving (page-feeding) one preview image in the front row sequentially and gradually and reversing the front face to the back face, and then adopting it as the other-side preview image in the front row. For example, when one preview image in the front row is regarded as a front face, the preview image is gradually moved (page-fed) so that the front face and the back face are reversed. Thus, the operator sees a situation that the preview image is changed gradually from the front face to the back face. Thus, visibility of preview images is improved. Further, even in a case that a document consisting of a large number of document images are to be printed, the presence or absence of a printing error is checked reliably.

Further, the display control part 181 performs display such that the preview images in the front row cover a part of the preview image in the back row among the stacked preview images. Thus, at the time that the preview images are displayed in a stacked manner, the preview images in the front row cover a part of the preview image in the back row. That is, a part of the preview image in the back row is not shaded by the preview images in the front row. Thus, such a preview image in the back row is seen simultaneously to the preview images in the front row. Accordingly, the situation of the overall document is allowed to be seen together with the preview images in the front row. Thus, visibility is improved.

More specifically, the modes of displaying the preview images onto the display screen consists of the first display mode that display is performed in stereography and the second display mode that display is performed in the form of a plane figure. The stereographic display mode is described below first.

The display control part 181 has the function of displaying the reference surface in the display screen. Then, when the preview images are to be displayed in stereography, the display control part 181 displays on the display screen, for example, a state that the reference surface is viewed from oblique above.

In the case of stereographic display, the display control part 181 displays the preview images in a manner that a plurality of preview images are stood vertically on the reference surface and that two preview images in the front row oppose to each other at a given angle. The given angle is, for example, greater than or equal to 90 degrees and at least smaller than 180 degrees. In order that the two preview images in the front row should easily be seen, a preferred value for the above-mentioned angle is 100 degrees to 130 degrees or the like. Then, the reverse display control part 182 moves (page-feeds) the preview images gradually on the reference surface, and reverses the front face to the back face. By virtue of this, two pages of the document are displayed in a stereographic manner as if a two-page spread is stood vertically on a desk. Further, display is such that page feed is performed page by page. Thus, visibility is improved further.

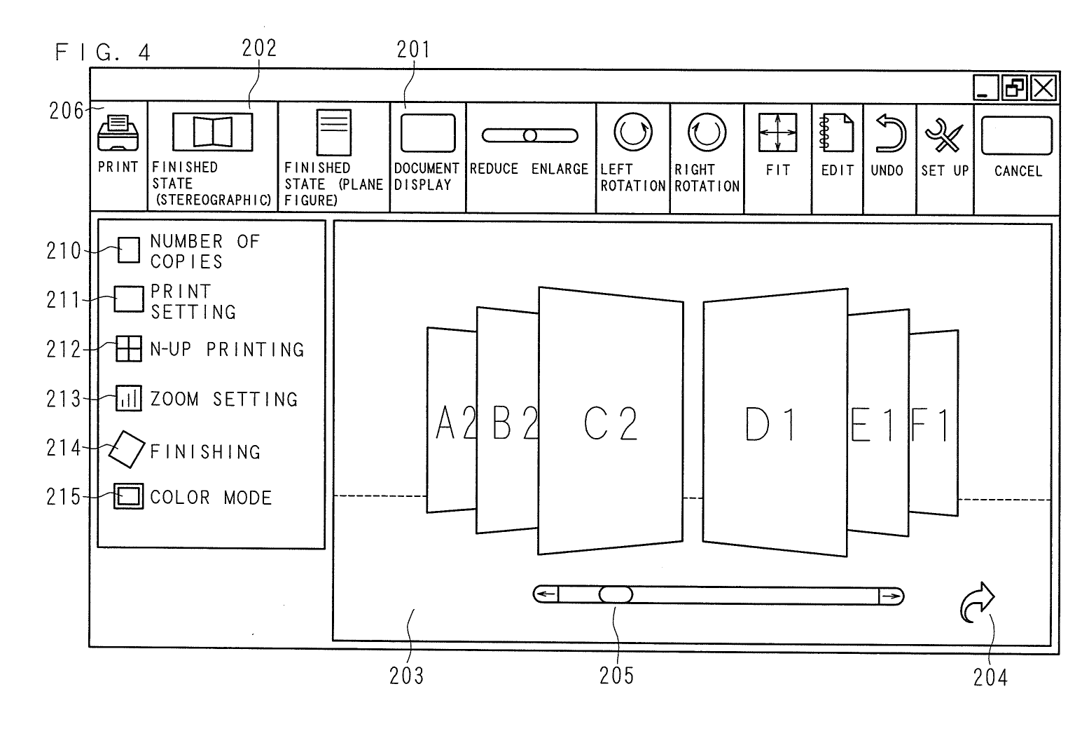

The stereographic display of the preview images performed by the display control part 181 may be implemented, for example, by using a general technique of projective transformation of a plane figure described in Patent Document 3. The display control part 181 performs the processing of virtually arranging the image of each page of the temporary file (the preview images) onto the reference surface at a given angle for each page, then performing projective transformation onto the image of each page arranged virtually so as to transform each image into a plurality of stereographic preview images (animation cells) constituting a video. As a result of this processing, preview images are obtained as illustrated in FIGS. 4 to 11 given later.

Next, when the preview images are displayed in the form of a plane figure, the display control part 181 has the function of displaying the placement surface in the display screen. In this case, the placement surface serves as a background surface of the entire display screen. Then, the display control part 181 performs display in a manner that two preview images in the front row are placed on the placement surface. By virtue of this, two pages of the document are displayed as if a two-page spread is placed on a desk. Further, display is such that page feed is performed page by page. Thus, visibility is improved further.

The page feed speed adjusting part 183 has the function of serving as a movement speed control part controlling the speed of movement (page feed) of the preview images performed by the reverse display control part 182.

For example, the page feed speed adjusting part 183 controls the speed of movement (page feed) of the preview images. For example, in an exemplary case that a user checks preview images, the user checks the preview images in a page-feed manner. This is so-called “skimming (skim reading)”. When skim reading is to be performed, the speed of page feed may be relatively high. This saves time. Nevertheless, a possibility arises that pages requiring care are skipped among the preview images so that printing mistakes are caused. In the configuration that the speed of movement (page feed) of the preview images is controlled such that, for example, page feed is stopped temporarily or alternatively the speed of page feed is set reduced so that the user's attention is attracted, printing mistakes are reduced.

Further, the page feed speed adjusting part 183 controls the speed of movement (page feed) of the preview images depending on the stereographic display mode (the first display mode) or the plane-figure display mode (the second display mode). For example, the stereographic display mode is a mode that document images before printing are displayed in stereography, and is an aspect that two pages of the document are displayed in stereography as if a two-page spread is stood vertically on a desk. For example, the plane-figure display mode is a mode that document images before printing are displayed in the form of a plane-figure, and is an aspect that two pages of the document are displayed as if a two-page spread is stood vertically on a desk. For example, in the stereographic display mode, the page feed speed adjusting part 183 assumes that the relation of the front face and the back face of a document sheet is to be checked rapidly, and hence sets the speed of page feed to be relatively high. In the plane-figure display mode, the page feed speed adjusting part 183 assumes that the contents of each page of the document is to be checked carefully, and hence sets the speed of page feed is set relatively low. Thus, the speed of movement (page feed) of the preview images is allowed to be changed in accordance with the display mode for the preview images. This improves visibility and convenience to the operator.

The editing condition judging part 184 has the function of serving as an editing condition judging part judging an editing condition for the document. The page feed speed adjusting part 183 controls the speed of movement (page feed) of the preview images in accordance with the editing condition judged by the editing condition judging part 184. For example, when a given editing condition is set up, the page feed speed adjusting part 183 is allowed to perform control such that, for the purpose of checking whether the editing condition is reflected correctly, the speed of movement (page feed) of the preview images is set to be relatively low or alternatively stopped temporarily. Thus, careful and with-sufficient-time checking is allowed to be performed on parts easily suffering erroneous printing depending on the editing condition. This avoids erroneous printing.

Further, the editing condition judging part 184 judges the presence or absence of a chapter change in the document. Then, in case of the presence of a chapter change in the document, the page feed speed adjusting part 183 reduces the speed of movement (page feed) of the preview images of the document or alternatively stops temporarily the movement (page feed). This allows reliable checking of parts easily suffering erroneous printing, like a chapter change in the document. Here, such chapter changes are, at the time of preparation of the document performed by a document preparation application, included into the data of the document, for example, in the form of information indicating that each chapter is to be located at a certain location at a certain page.

Further, the editing condition judging part 184 judges the presence or absence of a size change in the document. Then, in case of the presence of a size change in the document, the page feed speed adjusting part 183 reduces the speed of movement (page feed) of the preview images of the document or alternatively stops temporarily the movement (page feed). This allows reliable checking of parts easily suffering erroneous printing, like a size change in the document. Here, such size changes are, at the time of preparation of the document performed by a document preparation application, included into the data of the document, for example, in the form of information indicating that each page is to be formed in a certain size.

Further, the editing condition judging part 184 judges the document size. Then, in accordance with the document size, the page feed speed adjusting part 183 controls the speed of movement (page feed) of the document images of the document. For example, like in the case of A2, A3, or the like, when the document size is larger than an ordinary size (e.g., A4), the area to be checked is necessarily large. Thus, the speed of page feed is set reduced. Further, like in the case of B6, A5, or the like, when the document size is smaller than the ordinary size, the area to be checked is necessarily small. Thus, the speed of page feed is set increased. By virtue of this, the speed of page feed is changed depending on the expected number of parts easily suffering erroneous printing, like the document size. This permits rapid and reliable checking.

In order to allow the operator to perform given operation in the display screen of the display part 14, the operation part 185 displays operation buttons (e.g., icons), bars, and the like. The operation part 185 receives print conditions for the preview images displayed on the display screen. Such conditions include: the number of copies of the document to be printed; print setting indicating whether single-sided printing or double-sided printing; N-Up printing in which the page assignment number is set up that specifies the number of document pages to be assigned to one sheet; finishing in which the binding position of the sheets is set up; and a color mode that specifies a print color. The print conditions received through the operation part 185 are reflected in the re-display of the preview images, and imparted newly to the temporary file (EMF data) and then the temporary file is updated.

Further, the operation part 185 displays on the display screen, for example: a “print” button for printing execution; and a “finished state (stereographic)” button, a “finished state (plane figure)” button, and a “document display” button each specifying a display mode of preview display. Further, the operation part 185 receives operation of each button.

In accordance with the received print condition, the page feed speed adjusting part 183 controls the speed of preview image movement (page feed). For example, when a given print condition is set up, for the purpose of checking whether the print condition is reflected correctly, the page feed speed adjusting part 183 is allowed to perform control such that the speed of movement (page feed) of the preview images is set to be relatively low or alternatively stopped temporarily. Thus, careful and with-sufficient-time checking is allowed to be performed on parts easily suffering erroneous printing depending on the print condition. This avoids erroneous printing.

As a print condition, for example, a print color specification or alternatively a value for the page assignment number is allowed to be received. For example, the print color specification is distinction between color and monochrome. For example, when printing is to be performed in color, the number of to-be-checked items, like color tone, increases. Thus, the page feed speed adjusting part 183 sets the speed of page feed to be relatively low. Further, when printing is to be performed in monochrome, the number of to-be-checked items decreases in comparison with the case of color printing. Thus, the page feed speed adjusting part 183 sets the speed of page feed to be relatively high. Further, the page assignment number indicates the number of document pages to be assigned to one sheet. For example, in case of a high page assignment number, in order that page-to-page balance or the like is allowed to be checked easily, the page feed speed adjusting part 183 sets the speed of page feed to be relatively high. Then, in case of a low page assignment number, in order that each page is allowed to be checked carefully, the page feed speed adjusting part 183 sets the speed of page feed to be relatively low. Thus, careful and with-sufficient-time checking is allowed to be performed on parts easily suffering erroneous printing depending on the print condition. This avoids erroneous printing.

Further, as a print condition, specification of the binding position of the sheets is allowed to be received. The page feed speed adjusting part 183 sets the speed of movement (page feed) of the preview images to be identical for both cases of top binding and of left or right binding. Thus, in either case of top binding or of left or right binding, page feed is performed at the same speed. Thus, the user's feeling of operation does not change regardless of the binding position of the sheets, and hence operation is achieved without uneasiness.

Further, when the binding position is located on the left side of the document, the reverse display control part 182 sets the direction of page feed of the preview images to be from right to left. Further, when the binding position is located on the top side of the document, the reverse display control part 182 sets the direction of page feed of the preview images to be from down to up. Further, when the binding position is located at the upper left of the document, the reverse display control part 182 sets the direction of page feed of the preview images to be from lower right to upper left. Thus, page feed is performed in a manner that the state of binding of the document is reproduced. Accordingly, check is performed in a state that the actually expected finished state like the sequence of the pages and the top and bottom of the document is reproduced. This permits easy finding of erroneous printing.

Further, the operation part 185 receives setting of a zoom factor (depth information) used for reduced or enlarged display of the preview images. That is, the operation part 185 has the function of serving as a position setting part setting up the depth position of the preview images in the front row on the reference surface.

For example, when arrangement is such that the depth position of the preview images in the front row is located on the far side (in the case of reduction or zoom out), the page feed speed adjusting part 183 assumes that the relation of the front face and the back face of each document sheet is checked rapidly, and hence sets the speed of page feed to be relatively high. Further, when arrangement is such that the depth position of the preview images in the front row is located on the near side (in the case of enlargement or zoom in), the page feed speed adjusting part 183 assumes that the contents of each page of the document is to be checked carefully, and hence sets the speed of page feed to be relatively low. Thus, the speed of movement (page feed) of the preview images is allowed to be changed in accordance with the display mode for the preview images. This improves visibility and convenience to the operator.

Further, the operation part 185 has the function of serving as a determination part determining whether the operation of reversing one preview image in the front row and then adopting it as the other-side preview image in the front row is to be performed manually or automatically. That is, by operating the operation part 185, the operator is allowed to determine whether the page feed of the preview images is to be performed automatically or, alternatively, manually page by page. By virtue of this, when the operator desires rapid check, automatic page feed is available. Further, when the operator desires to carefully check the pages one by one, manual page feed is available. This improves convenience in accordance with the operator's desire.

The printing instruction sending part 15 transmits to the printer driver 16 the printing instruction based on the print condition set up in the preview display. Here, in practice, on the basis of the instruction from the printing instruction sending part 15, the preview application 18 transmits the printing instruction to the printer driver 16.

The printer driver 16 acquires printing data (EMF data) including print data, metadata associated with the printing, and print conditions set up in the preview display. Then, the printer driver 16 converts the acquired printing data into a language (e.g., PCL) used in the multi function peripheral or the printer. The printer driver 16 transmits the converted printing data to the image forming apparatus 20.

The image forming apparatus 20 includes: a control part 21 for controlling the entire apparatus; a communication part 22; a scanner part 23; an operation part 24; a display part 25; a printer part 26; and a storage part 27.

The communication part 22 exchanges given data with the image processing apparatus 10 or other external device through a network or a communication line. For example, the communication part 22 receives print data from the image processing apparatus 10. The print data received through the communication part 22 is stored into the storage part 27.

The scanner part 23 has an image read function implemented by a CCD or the like. The scanner part 23 is composed of an automatic document feeder (ADF) in which light is projected onto a document placed at a given position, then light reflected from the document is converted into an analog signal by photoelectric conversion in the CCD, and then the acquired analog signal is converted into a digital signal by an A/D converter (not illustrated). In the scanner part 23, the digital signal obtained by the conversion is stored as print data into the storage part 27.

Then, on the basis of the print data stored in the storage part 27, the printer part 26 forms (prints) an image on a sheet and then ejects onto a tray (not illustrated) the sheet on which the image is formed. The printer part 26 includes: a photosensitive material drum; an electrostatic charger electrostaically charging the photosensitive material drum into a given potential; a laser writing unit forming an electrostatic latent image on the photosensitive material drum surface; a developing unit supplying toner to the electrostatic latent image on the photosensitive material drum surface so as to bring the latent image into a visible image; and a transfer unit transferring onto a sheet the toner image on the photosensitive material drum surface (all of these units are not illustrated). Here, the printer part 26 is not limited to one employing electrophotography. That is, an inkjet method, a heat transfer method, or the like may be employed.

For example, the operation part 24 is composed of an operation panel of a touch panel method, and receives an operation instruction from the operator. For example, the display part 25 is composed of a liquid crystal display, and displays, to the operator, information like a result of operation or the like. Here, when the image processing apparatus 10 and the image forming apparatus 20 are to be integrated into a single apparatus (e.g., a multi function peripheral), the display part 14 may be integrated into the display part 25. In this case, the preview images are displayed on the display screen of the display part 25.

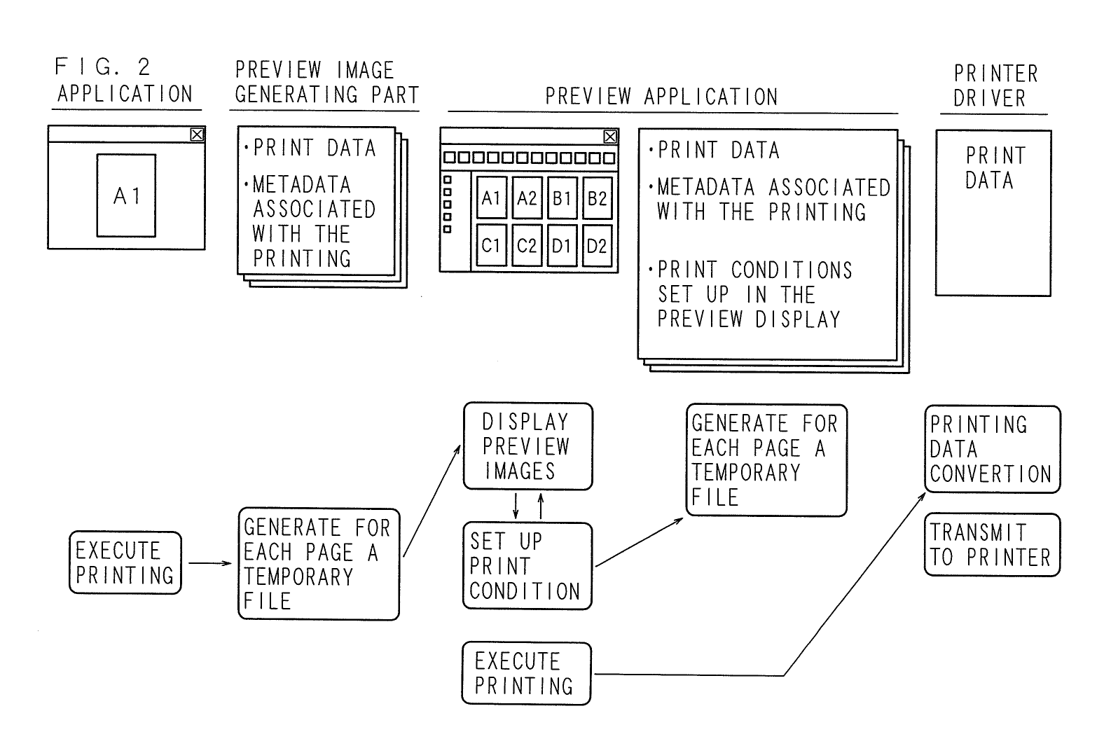

Next, operation of the image processing apparatus 10 according to the present embodiment is described below. FIG. 2 is a schematic diagram illustrating an example of an entire process of preview display performed by the image processing apparatus 10 according to the present embodiment. Preview display according to the present embodiment is implemented mainly by a document preparation application, a preview image generating part 13, a preview application 18, and a printer driver 16. As illustrated in FIG. 2, first, the operator opens the document preparation application or the like and then generates texts, diagrams, and the like, and then performs print button operation so as to execute printing.

When printing is executed on the application, the preview image generating part 13 is started. Then, on the basis of print data from the application, the preview image generating part 13 generates for each page a temporary file (EMF data) containing print data and metadata associated with the printing (e.g., information concerning the sheet size, the resolution, the sheet direction, and the like), so as to generate preview images.

When the temporary file (the preview images) has been generated, the preview application 18 displays the preview images onto the display screen of the display part 14. Then, the preview application 18 displays on the display screen: operation buttons (e.g., icons) used for receiving a display mode of preview display; operation buttons (e.g., icons) used for setting up a print condition; and the like. Then, when the operator has set up a print condition, preview images in which the set-up print condition is reflected are re-displayed. Thus, the operator is allowed to change a print condition in a state that the preview images are displayed, and then check the desired print condition before the printing. Further, at each time that a print condition is set up, the set-up print condition is imparted newly so that the temporary file (EMF data) is updated for each page.

In the preview display, when the operator executes printing, the preview application 18 transmits to the printer driver 16 the printing data (EMF data) including the print data, the metadata associated with the printing, and the print conditions set up in the preview display.

The printer driver 16 acquires printing data (EMF data) including print data, metadata associated with the printing, and print conditions set up in the preview display. Then, the printer driver 16 converts the acquired printing data into a language (e.g., PCL) used in the multi function peripheral or the printer. The printer driver 16 transmits the converted printing data to the image forming apparatus 20.

Next, a display example of preview display according to the present embodiment is described below. In the present embodiment, the preview display has three display modes consisting of a document display mode, a stereographic display mode, and a plane-figure display mode.

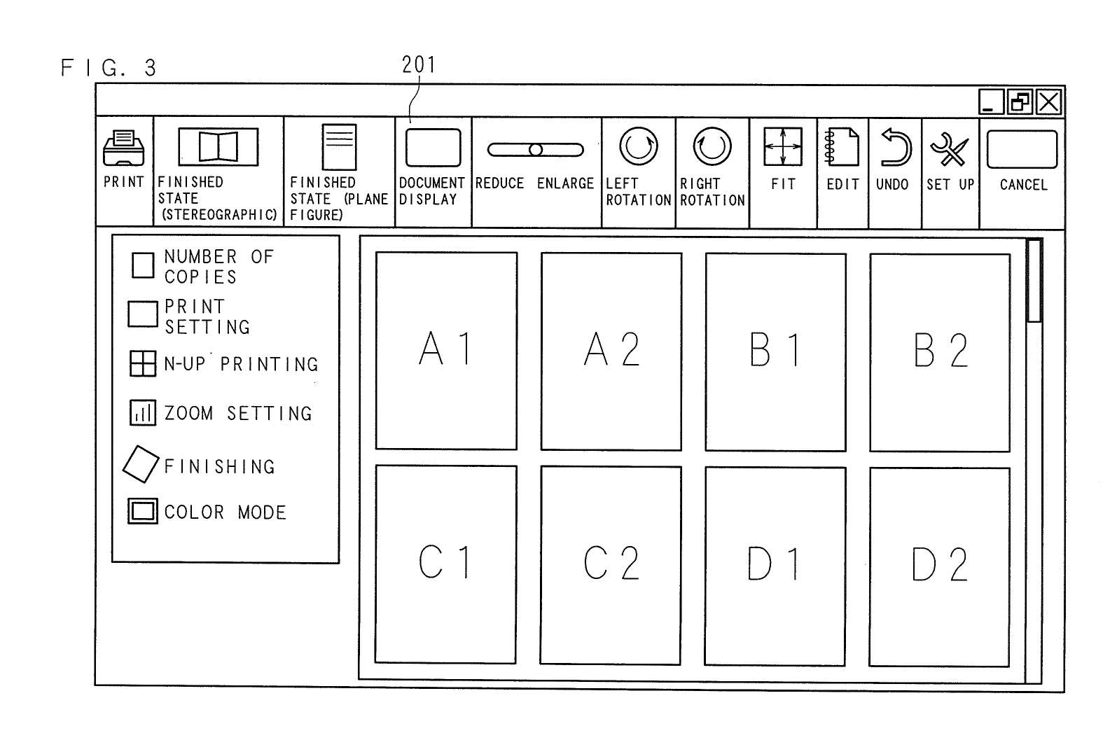

FIG. 3 is an explanation diagram illustrating an example of preview display in the document display mode according to the present embodiment. The document display mode is a display mode that the preview images are displayed as thumbnails. When the “document display” button 201 on the display screen is operated, thumbnail images of the plurality of document images are displayed as preview images as illustrated in FIG. 3. Here, the number of thumbnail images displayed on the display screen is eight in the example of FIG. 3. However, when the size of each image is changed, the number is allowed to be a desired value.

FIG. 4 is an explanation diagram illustrating an example of preview display in the stereographic display mode according to the present embodiment. In the stereographic display mode, preview images are displayed in a stereographic display mode (the first display mode). When the “finished state (stereographic)” button 202 on the display screen is operated, display is performed in a manner that the virtual reference surface 203 is viewed from oblique above as illustrated in FIG. 4. Further, preview images are displayed such that a plurality of preview images are stacked and stood on the reference surface 203 and that virtual surfaces respectively containing the two preview images in the front row (images indicated by “C2” and “D1” in FIG. 4) intersect with each other at an angle smaller than 180 degrees on the reference surface 203. The above-mentioned angle is an angle smaller than the 180 degrees, and preferably 90 degrees to 170 degrees or the like for the purpose of improvement of visibility of the preview images in the front row.

As illustrated in FIG. 4, when the automatic page feed button 204 is operated, one preview image in the front row is moved (page-fed) gradually and sequentially at given intervals of a given time length (e.g., one second per page) Then, the front face is reversed to the back face, and then it is adopted as the other-side preview image in the front row. For example, when one preview image in the front row is regarded as a front face, the preview image is gradually moved (page-fed) so that the front face and the back face are reversed. Thus, the operator sees a situation that the preview image is changed gradually from the front face to the back face. Thus, visibility of preview images is improved. Further, even in a case that a document consisting of a large number of document images are to be printed, the presence or absence of a printing error is checked reliably.

Further, as illustrated in FIG. 4, operation of the manual page feed button 205 permits such operation that at each time that one preview images in the front row is operated, sequential movement (page feed) is performed and the front face is reversed to the back face, and then it is adopted as the other-side preview image in the front row.

Further, as illustrated in FIG. 4, when the “number of copies” button 210 is operated, the print copies of the document is allowed to be set up. Further, when the “print setting” button 211 is operated, for example, double-sided printing or single-sided printing is allowed to be set up. Further, when the “N-Up printing” button 212 is operated, the page assignment number is allowed to be set up. As for the page assignment, for example, 1, 2, 4, 6, 8 or the like pages of the document is allowed to be assigned to one sheet. Further, when the “zoom setting” button 213 is operated, the depth of the preview images is allowed to be changed in the stereographic display mode, and reduction or enlargement of the preview images is allowed in the plane-figure display mode. Further, when the “finishing” button 214 is operated, the binding position of the sheets is allowed to be set up. Further, when the “color mode” button 215 is operated, for example, full color printing, gray scale printing, monochrome printing, or the like is allowed to be selected. When a print condition is set up by operation of each of the above-mentioned buttons 210 to 215, the printing data is updated each time.

Further, as illustrated in FIG. 4, when the “print” button 206 is operated, the preview application 18 transmits to the printer driver 16 the printing data (EMF data) including the print data, the metadata associated with the printing, and the print conditions set up in the preview display.

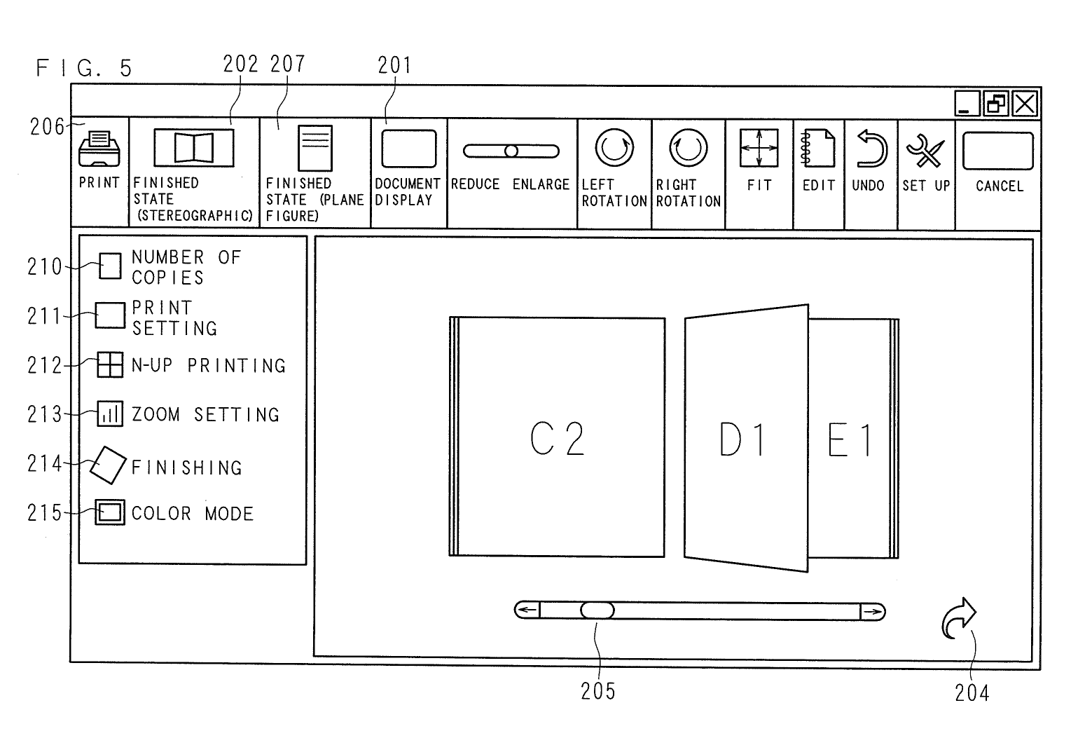

FIG. 5 is an explanation diagram illustrating an example of preview display in the plane-figure display mode according to the present embodiment. In the plane-figure display mode, preview images are displayed in a plane-figure display mode (the second display mode). When the “finished state (plane figure)” button 207 on the display screen is operated, as illustrated in FIG. 5, display is performed in a manner that two preview images in the front row are located in plane. By virtue of this, two pages of the document are displayed as if a two-page spread is placed on a desk. Further, display is such that page feed is performed page by page. Thus, visibility is improved further. Here, the other operation buttons are similar to those illustrated in FIG. 4. Thus, like numerals are designated and their description is omitted.

When the operator operates the “document display” button 201, the “finished state (stereographic)” button 202, or the “finished state (plane figure)” button 207 in the preview display, the preview display is allowed to be switched arbitrarily at each time of the operation among the three display modes consisting of the document display mode, the stereographic display mode, and the plane-figure display mode. This provides a wide variety of selection of the mode of checking the expected finished state of the document in accordance with the desire of the operator, and hence improves the operator's convenience.

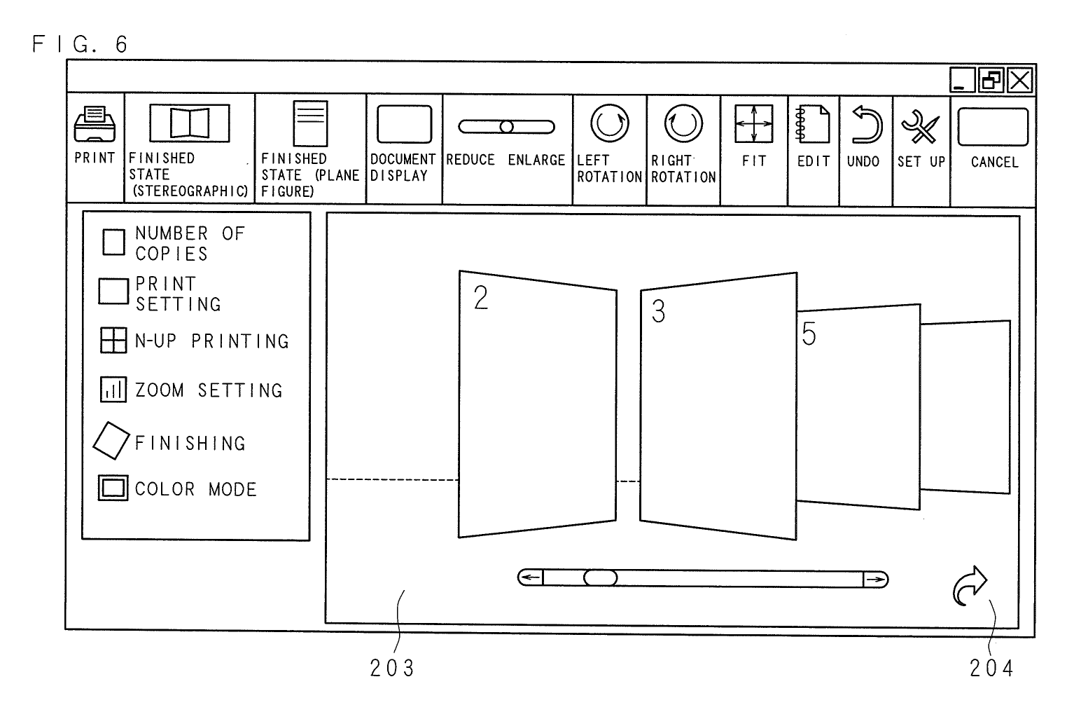

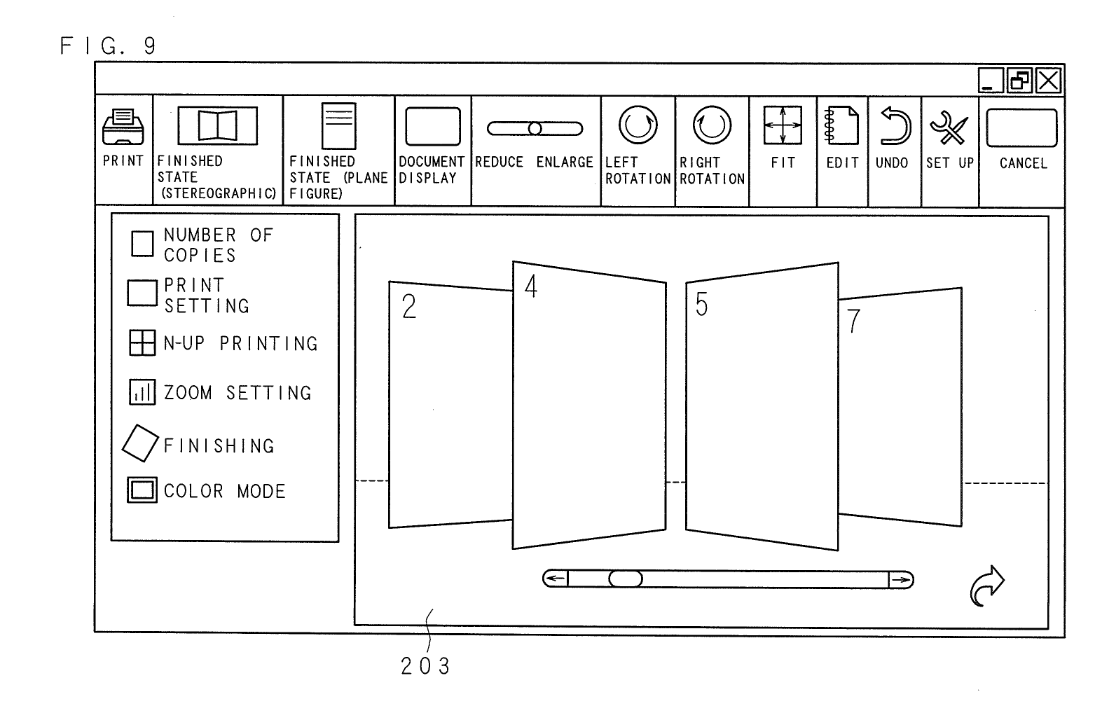

Next, page feed of the document is described below. FIGS. 6 to 9 are explanation diagrams illustrating an example of change in the page feed in the stereographic display mode according to the present embodiment. FIGS. 6 to 9 illustrate a situation that page feed of the preview images is performed gradually as time advances. The order of time elapse is equal to the order of FIGS. 6, 7, 8, and 9. Here, in the case of automatic page feed, the transition time from the state illustrated in FIG. 6 to the state illustrated in FIG. 9 is 1 second or the like. However, the speed of page feed is allowed to be changed as described above.

First, in FIG. 6, preview images are displayed such that a plurality of preview images are stacked and stood on the reference surface 203 and that virtual surfaces respectively containing the two preview images in the front row (images indicated by “2” and “3” in FIG. 6) intersect with each other at an angle smaller than 180 degrees on the reference surface 203. In the example of FIG. 6, the above-mentioned angle is 120 degrees or the like. Further, the preview image indicated as “3” is stacked such as to shade merely a part of the preview image indicated as “5” in the back row. The situation is similar to the preview image indicated as “5”.

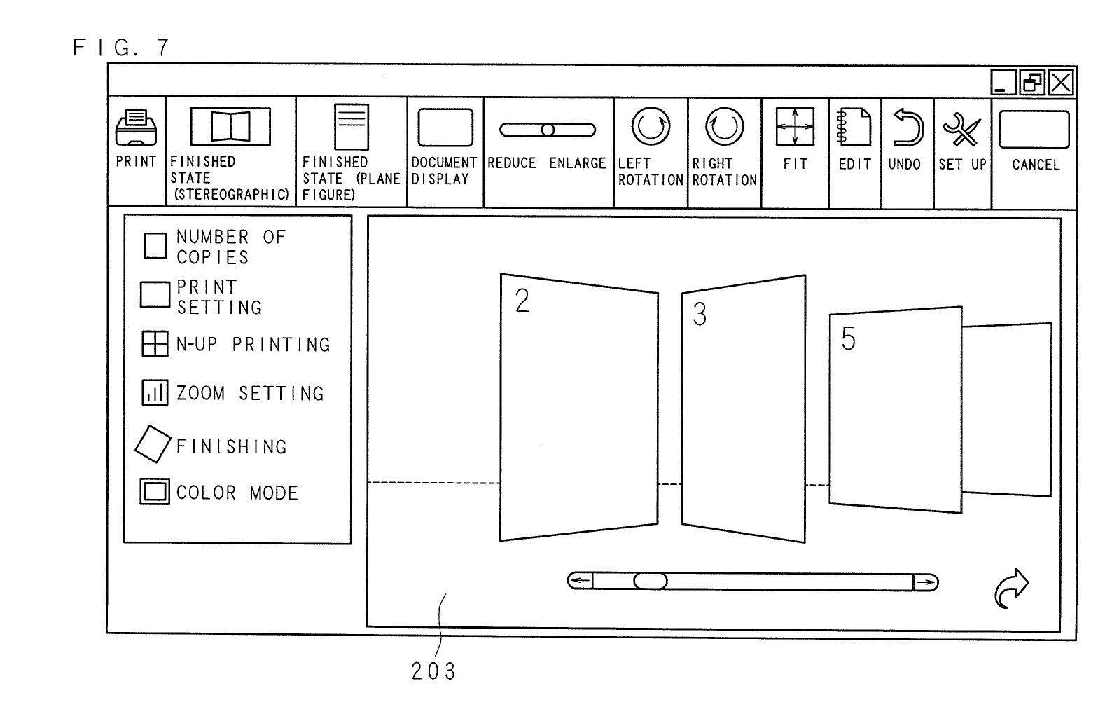

Next, in FIG. 7, page feed is started gradually for the preview image indicated as “3” which is one preview image in the front row. Thus, in FIG. 6, a part of the preview image indicated as “5” has been covered by the preview image indicated as “3”. In FIG. 7, the entirety of the preview image indicated as “5” is recognized visually.

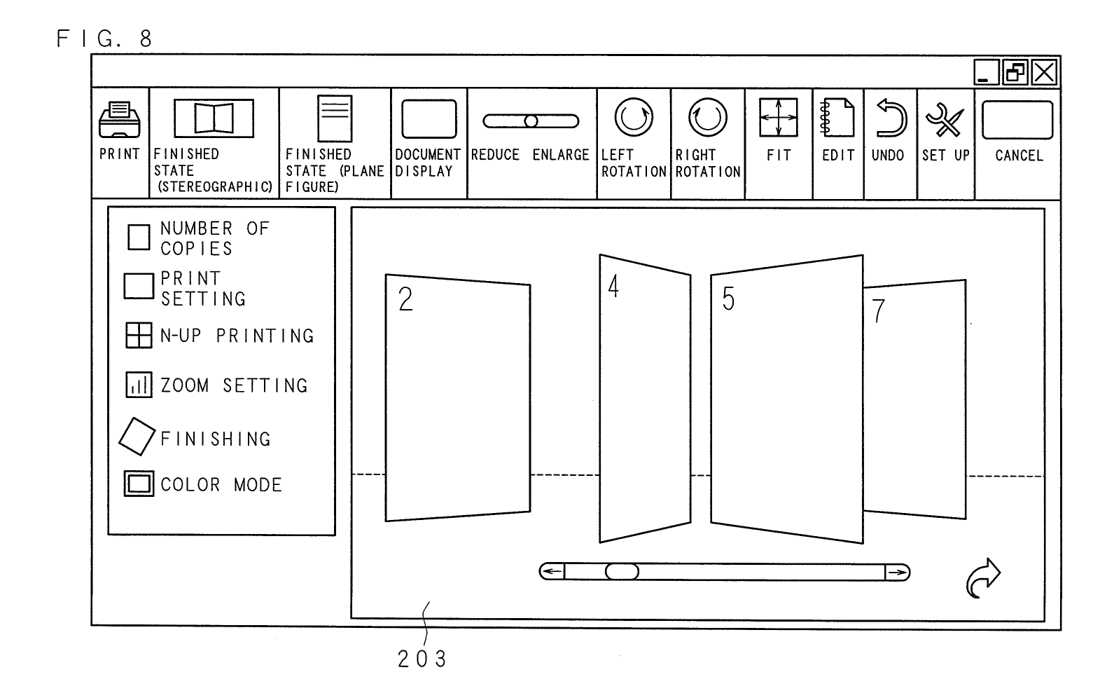

Next, in FIG. 8, page feed of the preview image indicated as “3” which is one preview image in the front row advances further. That is, the front face of the page is reversed to the back face and hence the preview image indicated as “4” on the back side begins to appear. Here, at this time, the preview image indicated as “2” which is the other-side preview image in the front row is also moved with being rotated backward on the reference surface 203. Further, the preview image indicated as “5” located in the back row of the preview image indicated as “3” is also moved with being rotated backward on the reference surface 203, so as to gradually serve as the preview image in the front row.

In FIG. 9, as a result of the page feed, the preview image indicated as “4” serves as the other-side preview image in the front row, and the preview image indicated as “5” serves as one preview image in the front row in place of the preview image indicated as “3” in FIG. 6. Similar page feed is repeated in the subsequent processing.

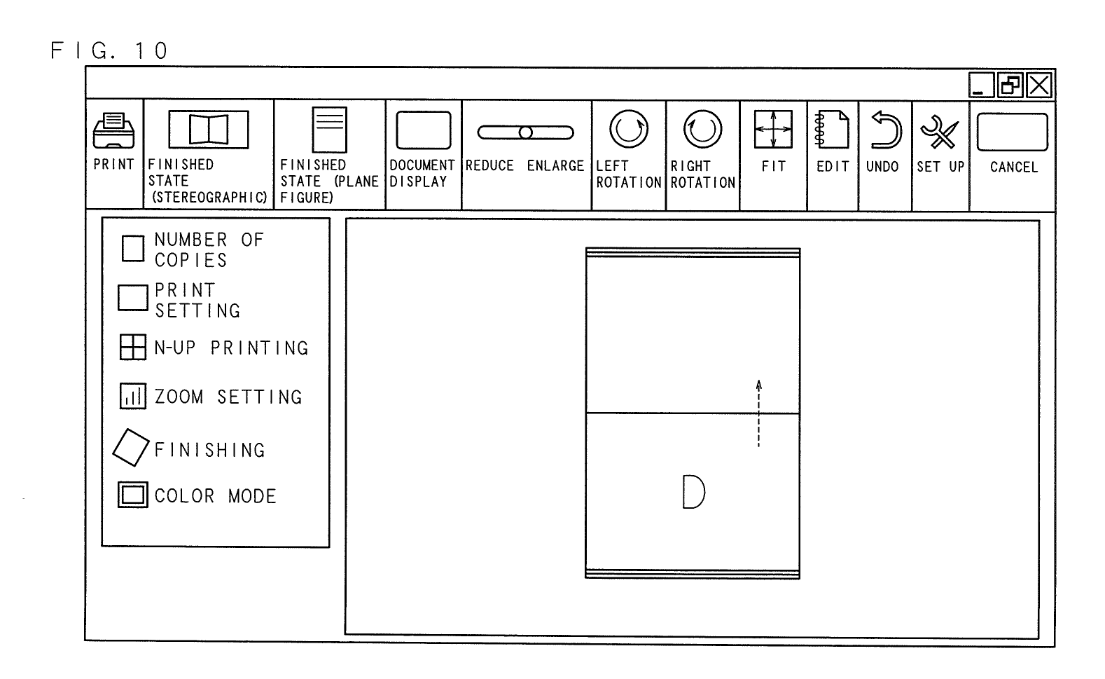

In the above-mentioned example, the binding position of the sheets has been on the left side. However, an employable position is not limited to this. FIG. 10 is an explanation diagram illustrating an example of preview display in a case of top binding according to the present embodiment. In the example of FIG. 10, the binding position is on the top side of the document. In this case, the reverse display control part 182 sets the direction of page feed of the preview images to be from down to top.

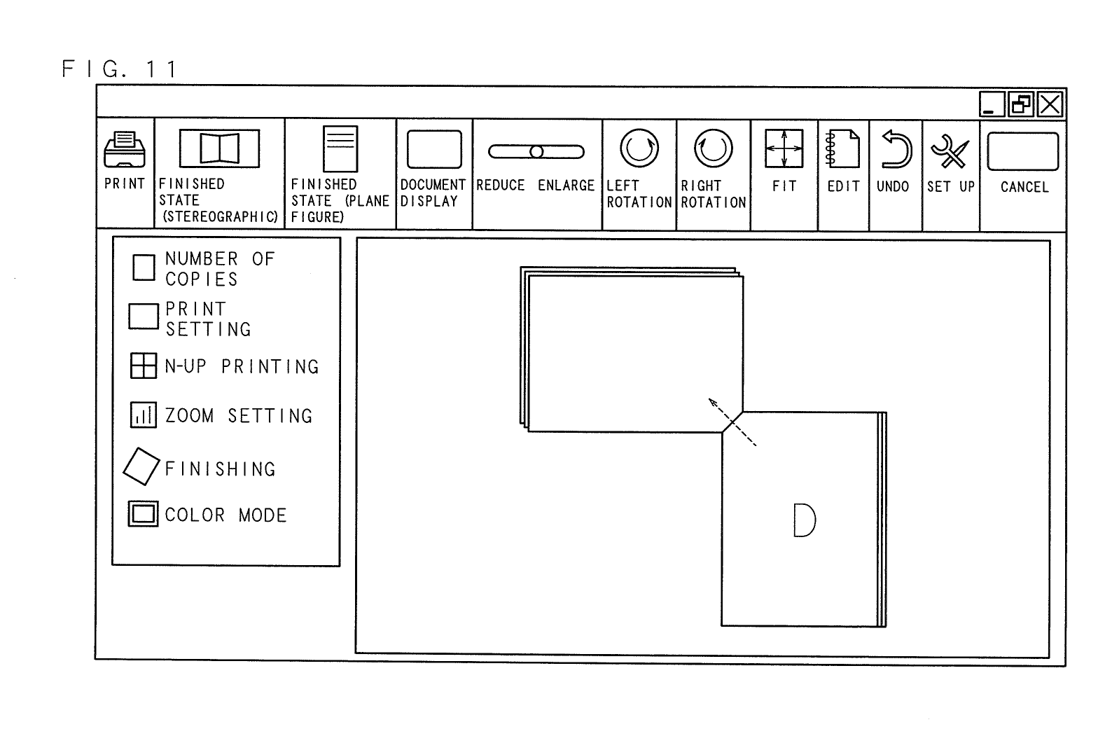

FIG. 11 is an explanation diagram illustrating an example of preview display in a case of upper left binding according to the present embodiment. In the example of FIG. 11, the binding position is located at the upper left of the document In this case, the reverse display control part 182 sets the direction of page feed of the preview images to be from lower right to upper left. As such, page feed is performed in a manner that the state of binding of the document is reproduced. Accordingly, check is performed in a state that the actually expected finished state like the sequence of the pages and the top and bottom of the document is reproduced. This permits easy finding of erroneous printing.

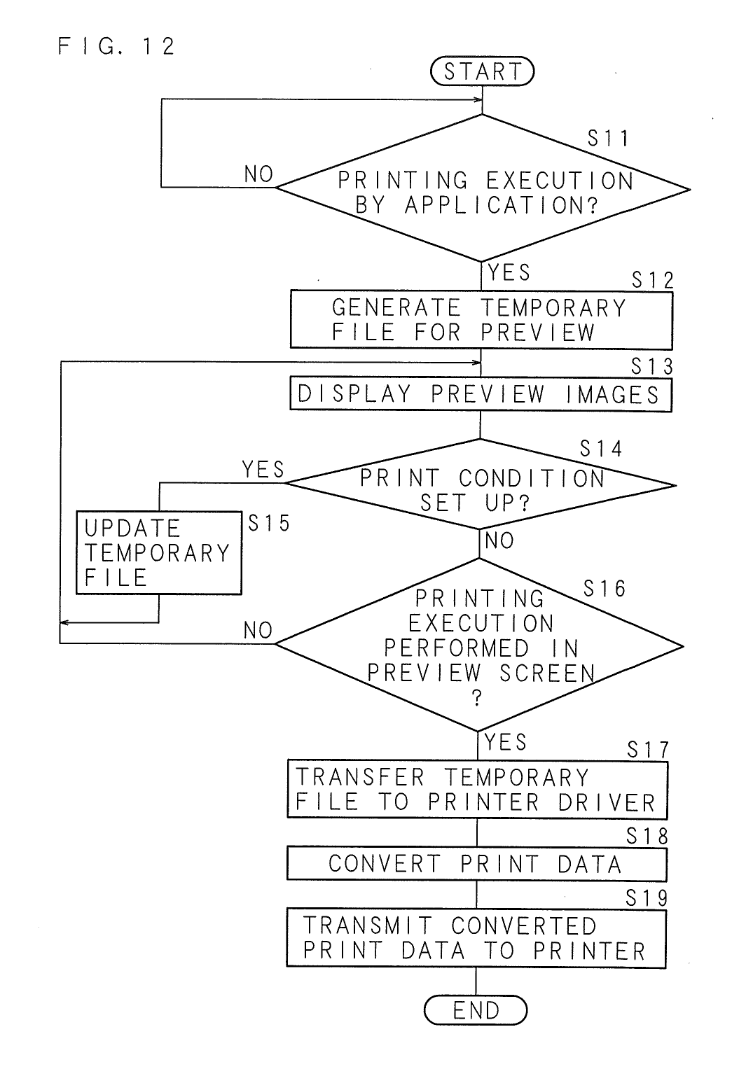

Next, operation of the image processing apparatus 10 according to the present embodiment is described below. FIG. 12 is a flow chart illustrating the entire processing procedure of preview display performed by the image processing apparatus 10 according to the present embodiment. Since the entirety of the image processing apparatus 10 is controlled by the CPU 11, the following description is given for a situation that the processing is performed by the CPU 11.

The CPU 11 judges whether printing execution has been performed by the document preparation application or the like (S11). Then, when printing execution has not yet performed (NO at S11), the processing at step S11 is continued. When printing execution has been performed (YES at S11), the CPU 11 controls the preview image generating part 13 so as to generates temporary file for preview (S12). As a result, preview images are generated page by page.

The CPU 11 controls the preview application 18 so as to display the preview images (S13). In this case, for example, preview display is performed in the document display mode. However, when the operator selects the stereographic display mode or the plane-figure display mode, preview images are displayed in the selected display mode. Further, in the preview display, for example, various kinds of operation buttons illustrated in FIGS. 3 to 5 are also displayed. Thus, as describes below, when the operator who checks the preview images changes suitably a print condition or the like, preview images in which the changed print condition has been reflected is allowed to be re-displayed.

The CPU 11 judges whether a print condition has been set up (S14). When a print condition has been set up (YES at S14), the temporary file is updated such that the set-up print condition is reflected (S15). Then, the processing at and after step S13 is performed.

When a print condition has not yet set up (NO at S14), the CPU 11 judges whether printing execution has been performed in the preview screen (S16). Then, when printing execution has not yet performed (NO at S16), the processing at and after step S13 is performed.

When printing execution has been performed in the preview screen (YES at S16), the CPU 11 transfers the temporary file to the printer driver (S17). The transferred temporary file contains print data, metadata associated with the printing, and print conditions set up in the preview display.

The CPU 11 controls the printer driver 16 so as to convert the print data into data in a language (PCL) used in the printer (the image forming apparatus 20) (S18), then transmit the converted print data to the printer (the image forming apparatus 20) (S19), and then terminate the processing.

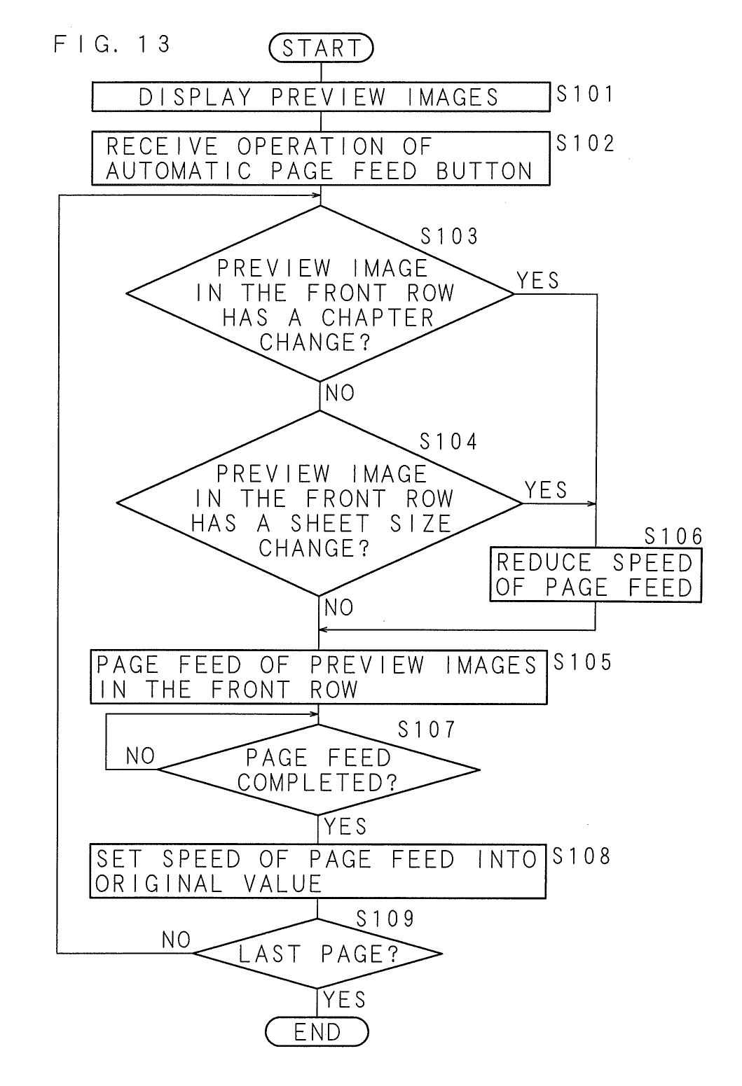

Next, details of the preview display are described below. FIG. 13 is a flow chart illustrating a processing procedure of preview display in a case that the page feed speed is set reduced according to the present embodiment. Here, the following description is given for a case that automatic page feed operation is performed. The CPU 11 controls the preview application 18 so as to display the preview images (S101), and then receives operation of the automatic page feed button (S102).

The CPU 11 judges whether the preview image in the front row under the page feed has a chapter change (S103). In case of the absence of a chapter change (NO at S103), the CPU 11 judges whether the preview image in the front row under the page feed has a sheet size change (a document size change) (S104).

In case of the absence of a sheet size change in the preview image in the front row under the page feed (NO at S104), the CPU 11 performs the page feed of the preview images in the front row without changing the speed of page feed (S105).

On the other hand, when the preview image in the front row under the page feed has a chapter change (YES at S103) or alternatively in case of the presence of a sheet size change in the preview image in the front row under the page feed (YES at S104), the CPU 11 reduces the speed of page feed (S106) and then performs the processing at step S105. In this case, when the speed of page feed is not changed, the speed of page feed is set to be, for example, 1 second per page. When the speed of page feed is set reduced, the speed of page feed may be set to be, for example, 3 seconds per page. Here, an employable value for the speed of page feed is not limited to the above-mentioned values, and an appropriate value may be employed.

The CPU 11 judges whether page feed for one page has been completed (S107). Then, when the page feed has not yet completed (NO at S107), the processing at step S107 is continued. When the page feed has been completed (YES at S107), that is, when one preview image in the front row has been adopted as the other-side preview image in the front row, the CPU 11 sets the speed of page feed into the original value (e.g., 1 second per page) (S108). Here, when the original value has already been set, the processing at step S108 is performed as reconfirming processing.

The CPU 11 judges whether the page feed is for the last page (S109). Then, when the page is not the last one (NO at S109), the CPU 11 performs the processing at and after step s103. When the page is the last one (YES at S109), the CPU 11 terminates the processing.

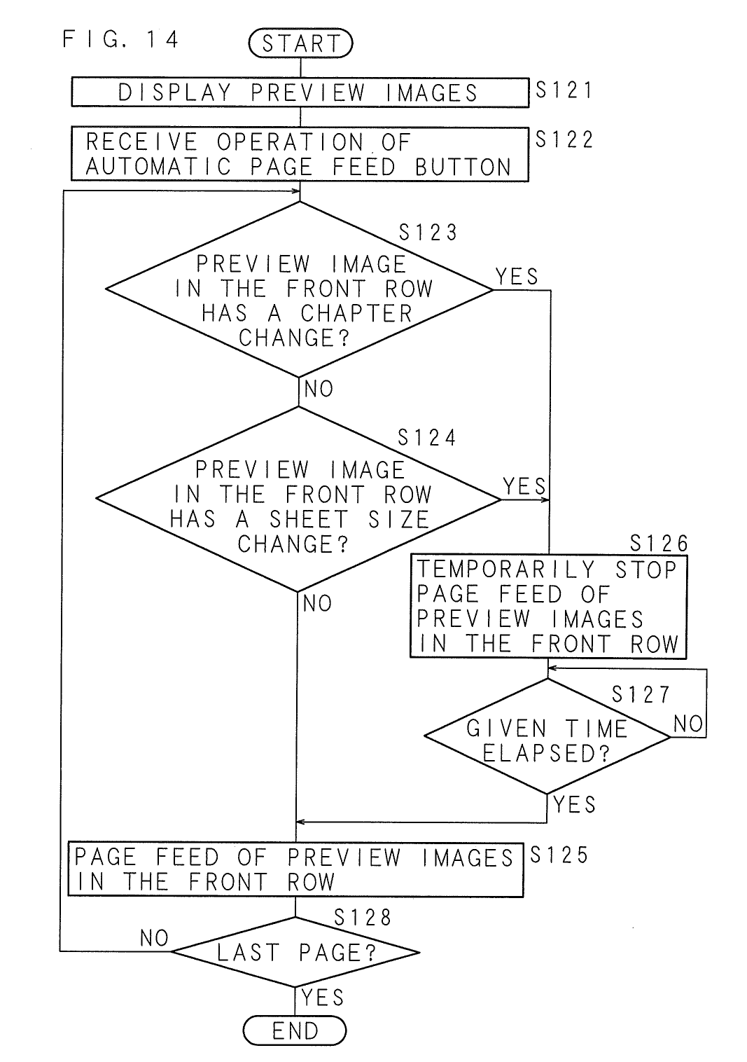

FIG. 14 is a flow chart illustrating the processing procedure of preview display in a case that page feed is stopped temporarily according to the present embodiment. The CPU 11 controls the preview application 18 so as to display the preview images (S121), and then receives operation of the automatic page feed button (S122).

The CPU 11 judges whether the preview image in the front row under the page feed has a chapter change (S123). In case of the absence of a chapter change (NO at S123), the CPU 11 judges whether the preview image in the front row under the page feed has a sheet size change (S124).

In case of the absence of a sheet size change in the preview image in the front row under the page feed (NO at S124), the CPU 11 performs the page feed of the preview images in the front row (S125).

On the other hand, when the preview image in the front row under the page feed has a chapter change (YES at S123), or alternatively in case of the presence of a sheet size change in the preview image in the front row under the page feed (YES at S124), the CPU 11 temporarily stops the page feed of the preview images in the front row (S126), and then judges whether a given time has been elapsed (S127). The given time may be set up appropriately, and may be, for example, 5 seconds.

When the given time has not yet elapsed (NO at S127), the CPU 11 continues the processing at step S127. When the given time has elapsed (YES at S127), the CPU 11 performs the processing at step S125.

The CPU 11 judges whether the page feed is for the last page (S128). Then, when the page is not the last one (NO at S128), the CPU 11 performs the processing at and after step S123. When the page is the last one (YES at S128), the CPU 11 terminates the processing.

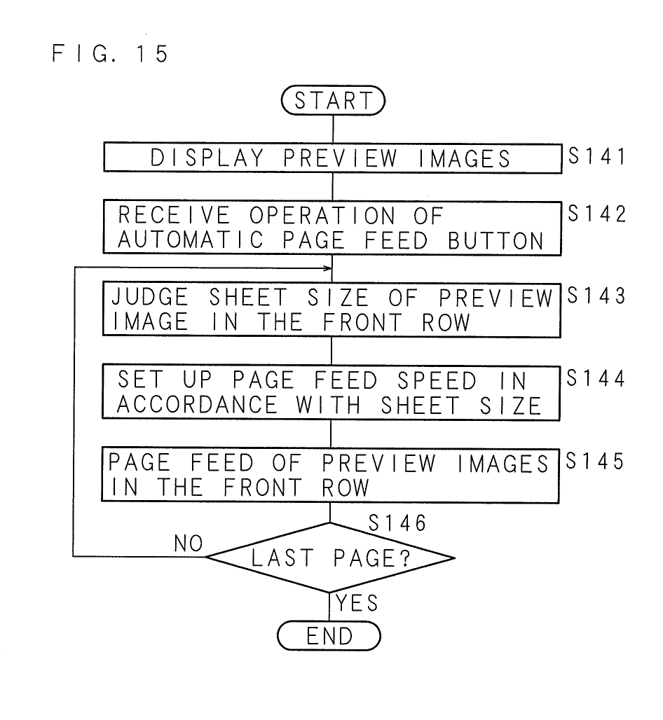

FIG. 15 is a flow chart illustrating the processing procedure of preview display in a case that the speed of page feed is changed according to the present embodiment. The CPU 11 controls the preview application 18 so as to display the preview images (S141), and then receives operation of the automatic page feed button (S142).

The CPU 11 judges the sheet size (the document size) of the preview image in the front row under the page feed (S143), and then sets up a page feed speed in accordance with the sheet size (S144). For example, like in the case of A2, A3, or the like, when the sheet size is greater than an ordinary sheet size (e.g., A4), the area to be checked is necessarily large. Thus, the speed of page feed is set reduced (e.g., 2 seconds per page). Further, like in the case of B6, A5, or the like, when the sheet size is smaller than the ordinary sheet size, the area to be checked is necessarily small. Thus, the speed of page feed is set increased (e.g., 0.5 second per page).

The CPU 11 performs the page feed of the preview images in the front row (S145). The CPU 11 judges whether the page feed is for the last page (S146). Then, when the page is not the last one (NO at S146), the CPU 11 performs the processing at and after step S143. When the page is the last one (YES at S146), the CPU 11 terminates the processing.

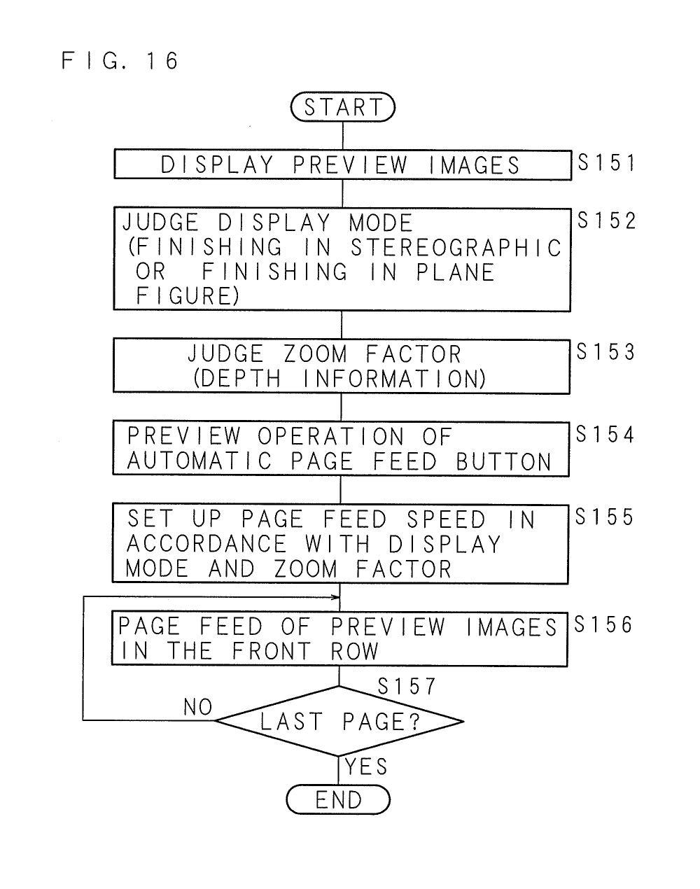

FIG. 16 is a flow chart illustrating another processing procedure of preview display in a case that the page feed speed is changed according to the present embodiment. The CPU 11 controls the preview application 18 so as to display the preview images (S151), and then judges the display mode (e.g., finishing in stereographic or finishing in plane figure) (S152). Then, the CPU 11 judges the zoom factor (the depth information) (S153). Here, as for the processing at step S152 and the processing at step S153, only any one of these may be performed alone.

The CPU 11 receives operation of the automatic page feed button (S154), then sets up the page feed speed in accordance with the display mode and the zoom factor having been judged (S155), and then performs the page feed of the preview images in the front row (S156).

The CPU 11 judges whether the page feed is for the last page (S157). Then, when the page is not the last one (NO at S157), the CPU 11 performs the processing at and after step S156. When the page is the last one (YES at S157), the CPU 11 terminates the processing.

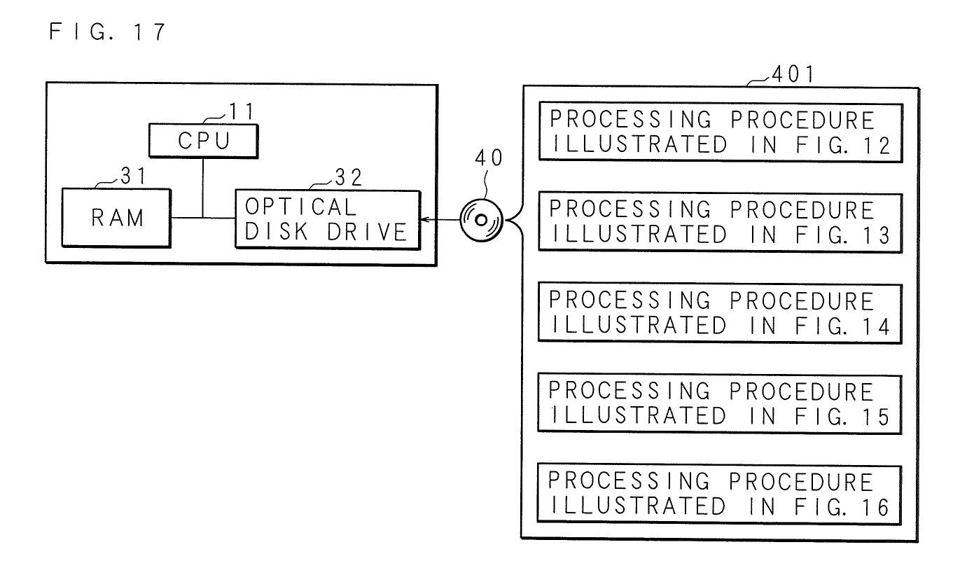

As illustrated in FIG. 17, a DVD storing a program code 401 describing the processing procedure illustrated in FIGS. 12 to 16 is inserted into an optical disk drive 32 so that the program code is loaded into the RAM 31 and then executed on the CPU 11. By virtue of this, the image processing apparatus 10 according to the present embodiment is implemented by the program code.

That is, as illustrated in FIG. 17, a computer-readable recording medium 40 storing a program code (an executable code program, an intermediate code program, or a source program) 401 to be executed on a computer may record the above-mentioned processing procedure (e.g., FIGS. 12 to 16). By virtue of this, a recording medium storing a program used for performing above-mentioned preview display processing is provided in a freely portable manner.

The recording medium storing a computer program according to the present embodiment stores a computer program causing a computer to execute a step of generating a plurality of document images on the basis of printing data of a document to be printed and then displaying the generated document images on a display screen, wherein the computer program includes: a display control step of causing the computer to stack the plurality of generated document images and then display two adjacent document images into the front row in an aligned manner; and a reverse display control step of causing the computer to move one document image in the front row gradually and sequentially and reverse the front face to the back face and then adopt is as the other-side document image in the front row.

Here, in the present embodiment, this recording medium may be composed of a memory to be processed in a microcomputer (not illustrated) or alternatively a program media such as a ROM. Further, a program media may be employed that is read when the recording medium is inserted into a program read unit (not illustrated) provided as an external storage device.

In any case, the stored program code may be accessed and executed by a microprocessor. Alternatively, the program code may be read, then the read-out program code may be downloaded onto a program storage area of the microcomputer (not illustrated), and then the program code may be executed. In this case, a computer program used for download is stored in advance in the main apparatus.

Here, the program medium is a recording medium removable from the main apparatus, and may be a medium that carries a program code in a fixed manner like: a tape device such as a magnetic tape and a cassette tape; a disk device such as a magnetic disk (including a flexible disk and a hard disk) and an optical disk (including a CD-ROM, an MO, an MD, and a DVD); a card device such as an IC card (including a memory card) and an optical card; and a semiconductor memory such as a mask ROM, an EPROM (Erasable Programmable Read Only Memory), an EEPROM (Electrically Erasable Programmable Read Only Memory), and a flash ROM.

Further, the present embodiment has a system configuration allowed to be connected to a communication network including the Internet. Thus, a medium may be employed that carries the program code in a dynamical manner like downloading of the program code from the communication network. As such, in a case that the program code is downloaded from the communication network, a computer program used for download may be stored in advance in the main apparatus or alternatively may be installed from another recording medium. Here, the present invention may be implemented in the form of a computer data signal embedded in a carrier signal, in which the program code is implemented by electronic transmission.

The above-mentioned recording medium is read by a program read unit provided in a digital color image forming apparatus or a computer system, and then preview display (an image displaying method) described above is executed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing apparatus that includes an image generating part generating a plurality of document images on the basis of printing data of a document to be printed and that performs processing of displaying the generated document images onto a display screen, comprising:
a display control part performing control such as to stack the plurality of document images generated by the image generating part and display two adjacent document images into the front row in an aligned manner with each other; and
a reverse display control part moving gradually and sequentially one document image in the front row displayed by the display control part and reversing the front face to the back face, and then adopting it as the other-side preview image in the front row.

2. The image processing apparatus according to claim 1,
wherein the display control part performs displaying such that the document images in the front row cover a part of a document image in the back row among the stacked document images.

3. The image processing apparatus according to claim 1, further comprising
a movement speed control part controlling a speed of document image movement performed by the reverse display control part.

4. The image processing apparatus according to claim 3,
wherein the display control part displays the document images in such a manner that the plurality of document images are stood vertically on a reference surface in the display screen, in at least one of a first display mode that two document images in the front row face with each other at a given angle and a second display mode that the two document images in the front row is placed on a placement surface in the display screen, and
in accordance with the first display mode or the second display mode, the movement speed control part controls the speed of document image movement performed by the reverse display control part.

5. The image processing apparatus according to claim 4,
wherein the reverse display control part moves the document images gradually on the reference surface.

6. The image processing apparatus according to claim 1, further comprising:
an editing condition judging part judging an editing condition for the document; and
a movement speed control part controlling the speed of document image movement performed by the reverse display control part, in accordance with the editing condition judged by the editing condition judging part.

7. The image processing apparatus according to claim 6,
wherein the editing condition judging part judges the presence or absence of a chapter change in the document, and
in case of the presence of a chapter change in the document, the movement speed control part reduces the speed of the movement of the document images of the document or alternatively stops temporarily the movement.

8. The image processing apparatus according to claim 6,
wherein the editing condition judging part judges the presence or absence of a size change in the document, and
in case of the presence of a size change in the document, the movement speed control part reduces the speed of the movement of the document images of the document or alternatively stops temporarily the movement.

9. The image processing apparatus according to claim 6,
wherein the editing condition judging part judges the size of the document, and
in accordance with the size of the document, the movement speed control part controls the speed of movement of the document images of the document.

10. The image processing apparatus according to claim 1, further comprising:
a reception part receiving a print condition; and
a movement speed control part controlling the speed of document image movement performed by the reverse display control part, in accordance with the print condition received by the reception part.

11. The image processing apparatus according to claim 10,
wherein the reception part receives a print color specification or alternatively the number of document pages to be assigned to one page.

12. The image processing apparatus according to claim 1, further comprising:
a position setting part setting the depth position of the document images in the front row displayed by the display control part, on a reference surface in the display screen; and
a movement speed control part, in accordance with the position set up by the position setting part, controlling the speed of document image movement performed by the reverse display control part.

13. The image processing apparatus according to claim 1, further comprising:
a position setting part setting a binding position of sheets; and
a movement speed control part performing control such that the speed of document image movement performed by the reverse display control part should be identical for both cases of top binding and of left or right binding of the sheets set up by the position setting part.

14. The image processing apparatus according to claim 1, further comprising:
a position setting part setting a binding position of sheets; and
a switching part switching a direction of the document image movement performed by the reverse display control part, in accordance with the binding position set up by the position setting part.

15. The image processing apparatus according to claim 1, further comprising
a determination part determining whether the operation that one document image in the front row is reversed and then adopted as the other-side document image in the front row and that is performed through the reverse display control part is to be performed manually or automatically.

16. The image forming system comprising:
the image processing apparatus according to claim 1; and
an image forming apparatus forming images by using print data corresponding to the document images displayed by the image processing apparatus.

17. A non-transitory recording medium storing a computer program causing a computer to generate a plurality of document images on the basis of printing data of a document to be printed and then display the generated document images onto a display screen, the computer program comprising steps of:
causing the computer to stack the plurality of generated document images and then display two adjacent document images into the front row in an aligned manner with each other; and
causing the computer to move gradually and sequentially one document image displayed in the front row and reverse the front face to the back face, and then adopt it as the other-side document image in the front row.

18. An image displaying method employing an image processing apparatus that generates a plurality of document images on the basis of printing data of a document to be printed and that performs processing of displaying the generated document images onto a display screen, comprising steps of:
the image processing apparatus stacking and displaying the plurality of generated document images;
the image processing apparatus moving document images in the front row gradually and sequentially and reversing the front face to the back face; and
the image processing apparatus adopting sequentially the reversed document images as document images in the front row and displaying two adjacent document images into the front row in an aligned manner with each other.
